(19) United States
(12) Patent Application Publication
(10) Pub. No.: US 2005/0153035 A1
(43) Pub. Date: Jul. 14, 2005

(54) Presentation board for freezing meat product

(75) Inventor: Barnet Liberman, New York, NY (US)

Correspondence Address: COHEN, PONTANI, LIEBERMAN & PAVANE, 551 FIFTH AVENUE, SUITE 1210, NEW YORK, NY, 10176, US

(73) Assignee: Winterlab Limited

(21) Appl. No.: 10/755,779

(22) Filed: Jan. 12, 2004

(51) Int. Cl. A23B 4/00

(52) U.S. Cl. 426/393

(57) ABSTRACT

A method for freezing a meat product on a die cut presentation board is disclosed. The presentation board comprises two opposite surfaces and a hole at the center of the presentation board. The hole is substantially covered with a heat conducting foil. The meat product together with the presentation board covered with the heat conducting foil is vacuum sealed in a bag prior to freezing.

### BACKGROUND OF THE INVENTION

1. Field of the Invention

The present invention relates to a presentation board for brine freezing meat products such as fish, pork, beef, and poultry. The presentation board in the present invention allows an efficient hear transfer between the meat products and the cooled brine for freezing.

2. Description of the Related Art

Many commercially smoked or cured fishes, such as salmon, are sliced, placed on a board or a tray and packaged in a plastic bag to be sold to consumers. The packaged fishes are usually frozen or thawed before they are sold.

Conventional methods of freezing protein products involve using air, blast freezing, tunnel freezing, or brine (antifreeze solution) which is cooled by a cooling medium, or immersing the cured meat products in liquid nitrogen or liquid carbon dioxide. These freezing methods result in a great amount of purge or drip from meat products, particularly when the meat product is smoked or cured, after thawing as the consequence of destruction of the tissues and cells. The destruction of tissues and cells causes loss of the meat weights and deterioration in taste and texture. This consequence becomes worse when the de-frozen cured meat products have to be frozen again from time to time.

U.S. Pat. No. 4,601,909 to Nagoshi discloses a Methods of Freezing Fishery Products. The method includes the steps of preparing a brine containing rapeseed oil, propylene glycol, calcium chloride and water, cooling the brine and immersing the seafood in the cooled brine until it is frozen. Such a brine prevents or reduces the breakdown of muscle tissue in the seafood due to ice crystal formation, as a result of such rapid and efficient freezing process. The resultant deterioration in quality from freezing is thus prevented.

However, in a brine freezing process, especially when the fishery products need to be placed on a presentation board and packaged before they are immersed in the brine, the uniformity and efficiency of such brine freezing process are usually compromised because the presentation board acts as a barrier to prevent the products from directly contacting the brine thereby affecting the heat transfer between the brine and the products and slowing down the freezing process.

U.S. Pat. No. 3,357,625 teaches a meat tray formed of pulpwood and having a transparent plastic window in the bottom wall for displaying meats and the like. The pulpwood portion of the tray has the ability to absorb and soaks up the meat juices, whereas the plastic window gives the desired visibility.

U.S. Pat. No. 3,700,096 teaches a reinforced food packaging tray having a window or opening in the bottom and is provided with an overwrap plastic film sealing the products therein. The reinforcement of the tray gives the side wall of the tray greater stability and strength.

UK Patent Application No. GB 2181399A teaches a vacuum skin package for a meat or fish product, which comprises a flexible card, printing on a first side of the card, printing on the second side of the card, a complex gas barrier layer on top of the printing on the second side of the card, and an uppermost gas barrier, skin, vacuum fused to the complex barrier layer to seal the meat product placed onto the complex barrier layer in an oxygen free or other gas impermeable manner. The underneath surface of the complex board may be provided with a window to allow viewing of the product form below.

None of the above references teaches the uses of those food packages in connection with a freezing process.

U.S. Pat. No. 3,934,789 discloses a meat spacer tray of molded plastic for freezing and storing meat wherein an open array of holes, ribs, and connectors permit free circulation of air around meats placed thereon and will hold odd-shaped cuts of meat. However, the patent does not suggest that such meat spacer tray is to be used in a brine freezing process.

Thus, there is a need in the meat freezing industry for a device that promotes uniform and rapid freezing sliced meat products on a presentation board in a brine.

### SUMMARY OF THE INVENTION

An object of the present invention is to provide a device for uniformly and rapidly freezing sliced meat products in a brine.

The device, according to the present invention, comprises a board for supporting a meat product, the center of the board being removed to facilitate the heat transfer between the meat product and the brine, a foil substantially covering the removed center of the board, a meat product placed thereon and being substantially supported by the perimeter of the board, and a vacuum sealed plastic bag enclosing the board and the meat product.

Preferably, the meat product is cured fish and most preferably smoked salmon.

In one embodiment of the present invention, the center of the board is removed in such a way that a portion of the board connecting the opposite sides of the perimeter is left so as to create an reinforcement member. Such reinforcement member provides a further support to the meat product.

In another embodiment of the present invention, the presentation board is covered with two heat conducting foils at the opposite surfaces of the presentation board.

In another embodiment of the present invention, the presentation board comprises multiple holes to facilitate the heat transfer between the meat product and the brine.

In another embodiment of the present invention, the presentation board is in the form of a mesh.

In a preferred embodiment, the meat product so packaged is frozen by a TruFresh® freezing process.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 is a side view of a meat product package, showing a presentation board and a meat product placed on the presentation board in a vaccum bag;

FIG. 2 shows an embodiment of the die cut presentation board;

FIG. 3 shows another embodiment of the presentation board with a reinforcement;

FIG. 4 shows a presentation board covered with a foil;

FIG. 5 shows a presentation board having multiple holes;

FIG. 6 is a top view of the presentation board in FIG. 5;

FIG. 7 is a bottom view of the presentation board in FIG. 5;

FIG. 8 shows an exemplary specification of the presentation board having multiple holes; and

FIG. 9 shows a presentation board in the form and shape of a TruFresh® logo.

### DETAILED DESCRIPTION OF THE PRESENTLY PREFERRED EMBODIMENTS

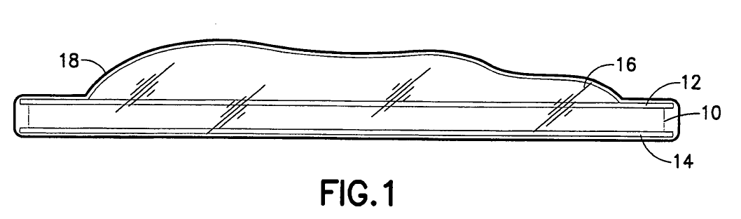

Referring now to FIG. 1, which is a side view of the present meat product package, the meat product package (1) comprises a presentation board (10) having two surfaces, a top foil (12) placed on one surface of the presentation board (10), a bottom foil (14) placed on the other surface of the presentation board (10), a meat product (16) placed on the top of either the top foil (12) or the bottom foil (14), and a bag (18) enclosing the presentation board (10), the top foil (12), the bottom foil (14) and the meat product (16).

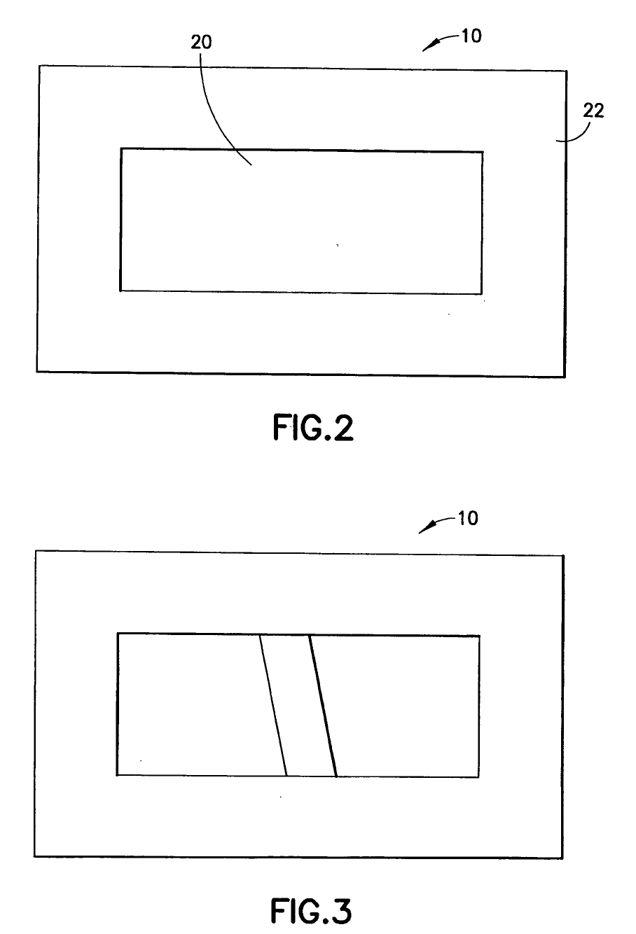

As show in FIG. 2, which is a top view of the presentation board (10), the center of the presentation board is removed to create a hole (20) such that the presentation board comprises a perimeter (22) and a hole (20). The hole (20) may be cut in any shapes such as a circle, a square, an oval, but preferably a rectangular.

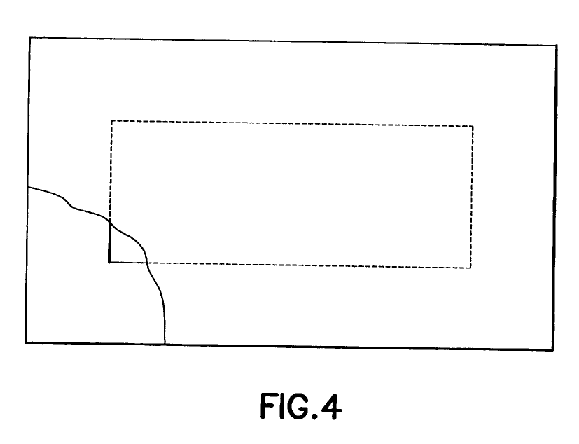

While the meat product thereon can be substantially supported by the perimeters of the presentation board, the hole (20) may be reinforced by an reinforcement member (30) if necessary to provide further support for the meat product placed thereon. The reinforcement member connects the perimeter (22) of the presentation board crossing the hole (20), as shown in FIG. 3, another top view of the presentation board (10). There may be more than one such reinforcement members. The presentation board may be formed of pulpwood, plastic, paper board, styrefoam, or any other materials that are obvious to a person of ordinary skill in the art. The dimensions of the hole (20) may vary depending on the size, weight and shape of the meat product to be placed on it. Generally, the hole should be cut as big as possible but still capable of substantially supporting the meat product that sits on the board.

The top foil (12) and the bottom foil (14) covering the surfaces of the presentation board (10) functions as a support for the meat product to be placed thereon, therefore, they should substantially cover the hole (20). FIG. 4 is a bottom view of the presentation board covered with the foils. In this specific example, the hole is covered by both of the top foil and the bottom foil. Alternatively, the hole (20) may be covered by either the top foil or the bottom foil. Because the hole is made for the purpose of facilitating heat transfer between the meat product and the cooling brine, the foil should be made of a heat conducting material. An example of such foil is aluminum foil.

When both top and bottom foils are present, which is preferred in the present application, a void is sometimes created between the two foils interfering the heat transfer between the meat product and the cooling brine. While this void may be avoided by pressing the two foils against each other such that the two foils meet each other and stick together, such void usually disappears after the meat product together with the presentation board and the foils is introduced into a bag and vacuum sealed, because of vacuuming.

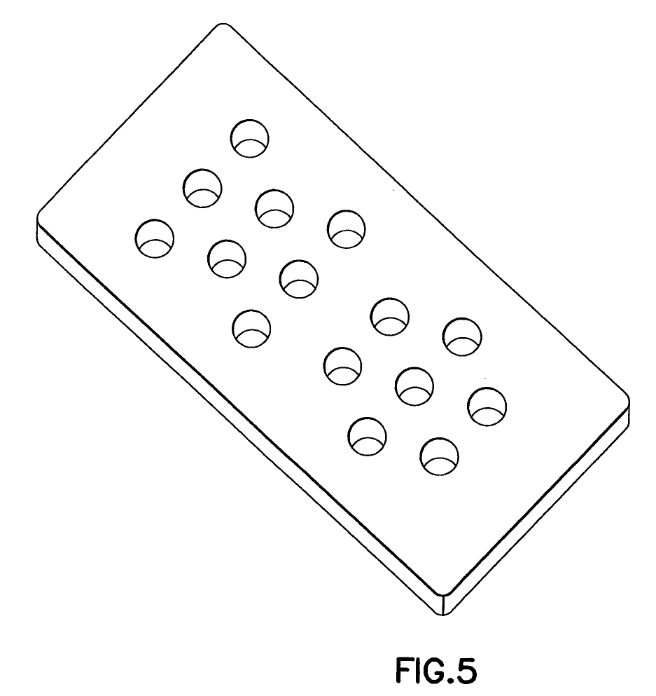

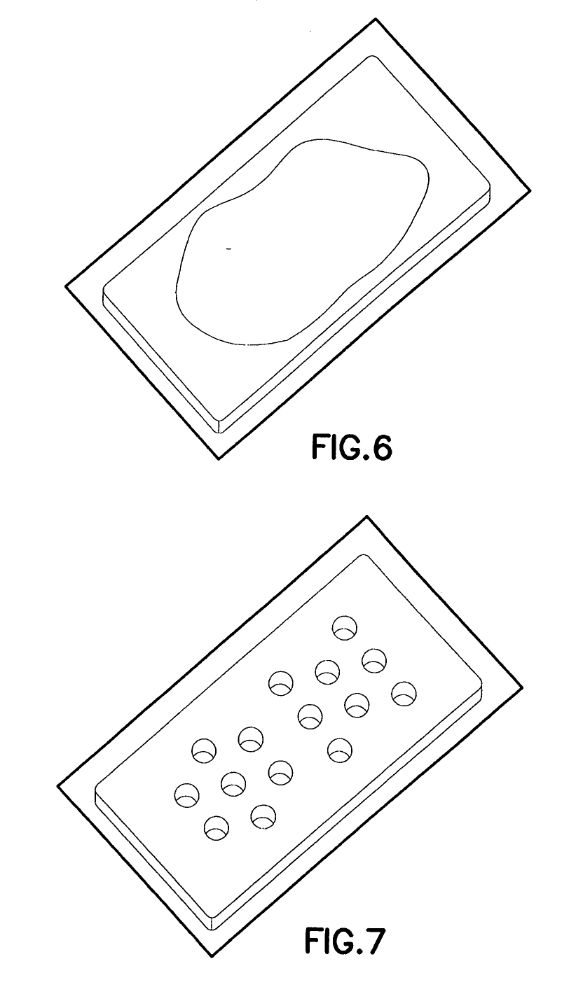

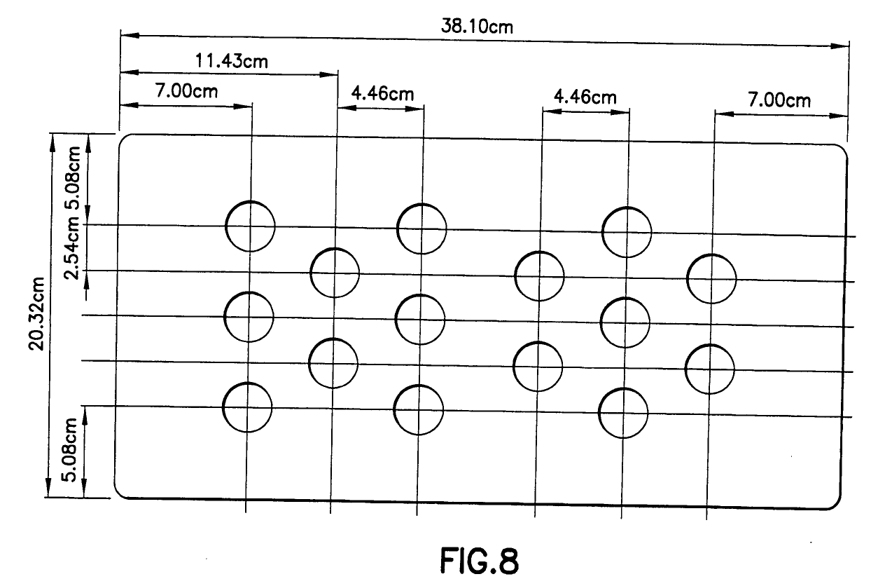

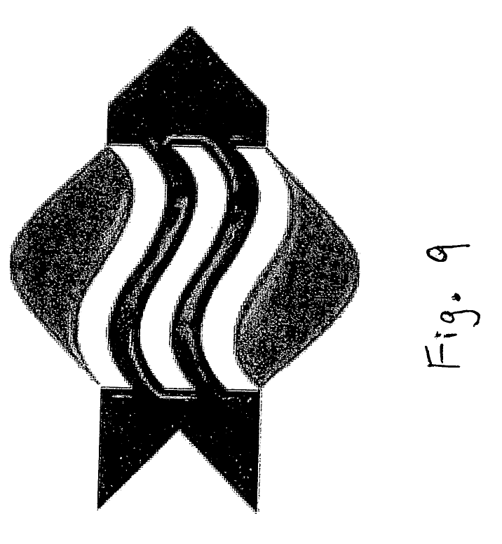

FIG. 5 depicts another embodiment of the present invention. As shown in FIG. 5, the presentation board may be made to have multiple holes to facilitate the heat transfer. In such case, it is unnecessary to wrap the board with a foil because such board with multiple holes provides sufficient support for the meat product that is placed on it. FIG. 6 is a top view of package showing a meat product on a presentation board having multiple holes. FIG. 7 is a bottom view of the same package as in FIG. 6, showing the multiple holes of the presentation board. FIG. 8 provides an exemplary specification of the board having multiple holes. It should be understood that the specification in FIG. 8 may be varied without departure from the scope of the present invention.

In another embodiment, the presentation board may be made in the form of a mesh. Since a mesh form board provides sufficient support for the meat product placed on it, this type of board does not need a foil to cover the surface.

Also in an additional embodiment, the presentation board may be carved in the form and shape of a logo, e.g. the TruFresh® logo as shown in FIG. 9.

The meat product in the present application means any meat product including fish, beef, pork or poultry. The meat product may be presented in an unsliced or sliced form. Thus, the form of the board, for example, a board wrapped with a foil or having multiple holes or in the form of a mesh as described above, depends on the form and size of the meat products to be frozen. For example, if the meat product is in an unsliced form, the board wrapped with a foil may be used. However, if the meat product has been sliced into multiple small pieces, a mesh board may be more appropriate.

After the meat product package is vacuum sealed, the package is ready to be frozen. While the present invention may be suitable for any conventional freezing method, a brine freezing process is preferred, and most preferably, the present meat product package is frozen using the “cooled-brine methods” (TruFresh®) disclosed in U.S. Pat. Nos. 4,601,909; 4,654,217; 4,657,768; 4,689,963; 4,743,343; 4,840,034; 4,840,035 and 5,001,047, the contents of which are incorporated herein by reference in their entireties. As described therein, these cooled-brine methods, unlike conventional freezing methods, advantageously maintain the freshness or tastiness of the meat by maintaining maximum cellular integrity of the meat tissue and minimizing the number of ruptured cells during the freezing process.

Although brine solutions of various compositions, as disclosed in the aforementioned cooled-brine method patents may be used, at least about 0.005% by weight of cruciferous oil is preferably included in the brine. Preferably, about 0.005% to 0.018% by weight of cruciferous oil such as rapeseed oil should be used. Alternatively, the amount of cruciferous oil may be selected such that a maximum amount of the oil is dissolved in the brine. Presently preferred brine composition include, by weight, bout 43.18% water, about 44.06% propylene glycol, about 12.75% calcium chloride, and about 0.01% rapeseed oil. The temperature of the brine should be between about −22° and −46° F., and preferably between about −37° and −41° F.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A method for freezing a meat product in a cooled brine, comprising the steps of
a) placing a meat product on a presentation board, wherein said presentation board comprises two opposite surfaces and a hole at the center of said presentation board to facilitate the heat transfer between said meat product and said cooled brine, said hole being substantially covered by a heat conducting foil placed on a surface of said presentation board;
b) introducing said presentation board together with said meat product into a bag;
c) vacuum sealing said bag after said meat product and said presentation board is introduced into said bag;
d) immersing said sealed bag into said cooled brine for freezing said meat products.

2. The method of claim 1, further comprises a second foil placed on the other surface of said presentation board, said second heat conducting foil also covering said hole.

3. The method of claim 2, wherein said presentation board further comprises at least a reinforcement member crossing said hole of said presentation board.

4. The method of claim 2, wherein said meat product is fish.

5. The method of claim 4, wherein said fish is sliced salmon.

6. The method of claim 1, wherein said meat product are frozen in said cooled brine containing at least about 0.005% by weight of a cruciferous oil.

7. The method of claim 6, wherein said cooled brine contains from about 0.005% to about 0.018% by weight of said cruciferous oil.

8. The method of claim 6, wherein said cruciferous oil is rapeseed oil.

9. The method of claim 6, wherein the temperature of said cooled brine is between about −22° and −46° F.

10. The method of claim 9, wherein the temperature of said cooled brine is between about −37° and −41° F.

11. A method for freezing a meat product in a cooled brine, comprising the steps of
a) placing a meat product on a presentation board, wherein said presentation board comprises multiple holes to facilitate heat transfer between the meat product and said cooling brine;
b) introducing said presentation board together with said meat product into a bag;
c) vacuum sealing said bag after said meat product and said presentation board is introduced into said bag;
d) immersing said sealed bag into said cooled brine for freezing said meat products.

12. The method of claim 11, wherein said meat product is fish.

13. The method of claim 12, wherein said fish is sliced salmon.

14. The method of claim 11, wherein said meat product are frozen in said cooled brine containing at least about 0.005% by weight of a cruciferous oil.

15. The method of claim 14, wherein said cooled brine contains from about 0.005% to about 0.018% by weight of said cruciferous oil.

16. The method of claim 14, wherein said cruciferous oil is rapeseed oil.

17. The method of claim 14, wherein the temperature of said cooled brine is between about −22° and −46° F.

18. The method of claim 17, wherein the temperature of said cooled brine is between about −37° and −41° F.

19. A method for freezing a meat product in a cooled brine, comprising the steps of
a) placing a meat product on a presentation board, wherein said presentation board is made in the form of a mesh;
b) introducing said presentation board together with said meat product into a bag;
c) vacuum sealing said bag after said meat product and said presentation board is introduced into said bag;
d) immersing said sealed bag into said cooled brine for freezing said meat product.

20. The method of claim 19, wherein said meat product is fish.

21. The method of claim 20, wherein said fish is sliced salmon.

22. The method of claim 19, wherein said meat product are frozen in said cooled brine containing at least about 0.005% by weight of a cruciferous oil.

23. The method of claim 22, wherein said cooled brine contains from about 0.005% to about 0.018% by weight of said cruciferous oil.

24. The method of claim 22, wherein said cruciferous oil is rapeseed oil.

25. The method of claim 22 wherein the temperature of said cooled brine is between about −22° and −46° F.

26. The method of claim 25, wherein the temperature of said cooled brine is between about −37° and −41° F.

27. A method for freezing a meat product in a cooled brine, comprising the steps of
a) placing a meat product on a presentation board, wherein said presentation board is made in the form and shape of a logo;
b) introducing said presentation board together with said meat product into a bag;
c) vacuum sealing said bag after said meat product and said presentation board is introduced into said bag;
d) immersing said sealed bag into said cooled brine for freezing said meat product.

28. The method of claim 27, wherein said meat product is fish.

29. The method of claim 28, wherein said fish is sliced salmon.

30. The method of claim 27, wherein said meat product are frozen in said cooled brine containing at least about 0.005% by weight of a cruciferous oil.

31. The method of claim 30, wherein said cooled brine contains from about 0.005% to about 0.018% by weight of said cruciferous oil.

32. The method of claim 30, wherein said cruciferous oil is rapeseed oil.

33. The method of claim 30 wherein the temperature of said cooled brine is between about −22° and −46° F.

34. The method of claim 33, wherein the temperature of said cooled brine is between about −37° and −41° F.

35. The method of claim 27, wherein said presentation board is made in the form and shape of a TruFresh® logo of FIG. 9.
